(19) United States
(12) Patent Application Publication
(10) Pub. No.: US 2008/0259375 A1
(43) Pub. Date: Oct. 23, 2008

(54) Adding features to electronic image files mimicking physical output of electronic printing data to assist testing and verification

(76) Inventors: Brandon Ashey, Boise, ID (US); Nataraj Kumar Gobbak, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/738,517

(22) Filed: Apr. 23, 2007

(51) Int. Cl. G06F 3/12

(52) U.S. Cl. 358/1.13

(57) ABSTRACT

Electronic printing data is received. The electronic printing data is adapted for a electromechanical print engine of a printing device to form images corresponding to the electronic printing data on physical media. One or more electronic image files are generated from and corresponding to the electronic printing data. The electronic image files mimic physical output of the electronic printing data as images on physical media by the electromechanical print engine. One or more features are added to the images of the electronic image files. The features are added to assist testing and/or verification of one or more of generation of a print job from which the electronic printing data is generated, generation of the electronic printing data from the print job, generation of the electronic image files, and formation of the images corresponding to the electronic printing data on physical media by the electromechanical print engine.

### BACKGROUND

To remain competitive, manufacturers and developers of printing devices, such as inkjet and laser printers, have to constantly improve their existing printing devices and design new printing devices. A printing device can include at least a controller and an electromechanical print engine. The controller, which may be or include firmware, generates electronic printing data from a received print job. The electronic printing data is adapted for the mechanical printing engine to actually physically output images on physical media, such as paper. The print job itself may be generated within a printing device of a host computing device, like a desktop or laptop computer.

Manufacturers and developers of printing devices have to test and verify many aspects within this process to ensure that the printing device satisfactorily physically outputs images on physical media. For instance, they may have to test and verify the generation of the print job. They may also have to test and verify the generation of the electronic printing data from the print job. Furthermore, they may have to test the actual formation of the images corresponding to the electronic printing data on the physical media by the electromechanical print engine. Such testing and verification is desirably performed accurately, yet quickly and in a cost-effective manner.

### BRIEF DESCRIPTION OF THE DRAWINGS

FIG. 1 is a diagram of an architecture within which testing and verification of a printing device can be performed, according to an embodiment of the invention.

FIG. 2 is a diagram of a representative image of a representative electronic image file that mimics physical output on physical media by a printing device, according to an embodiment of the invention.

FIG. 3 is a flowchart of a method for assisting testing and verification of a printing device, according to an embodiment of the invention.

### DETAILED DESCRIPTION OF THE DRAWINGS

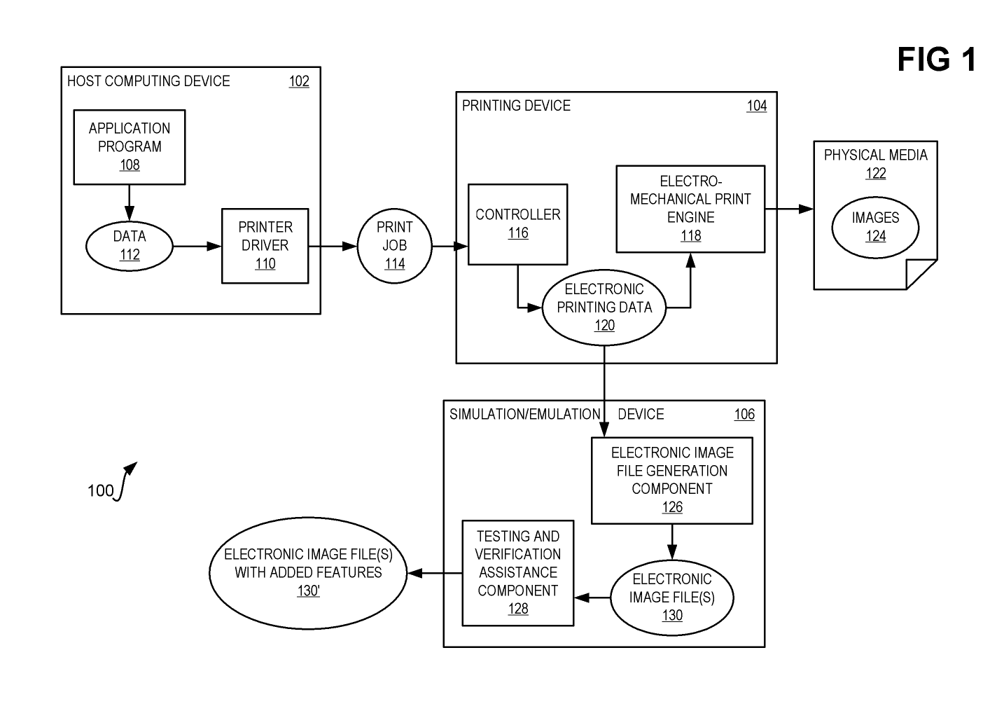

FIG. 1 shows an architecture, or system, 100 within which testing and verification of a printing device 104 can be performed, according to an embodiment of the invention. The architecture 100 includes a host computing device 102, the printing device 104, and a simulation/emulation device 106. As can be appreciated by those of ordinary skill within the art, the architecture 100 may include other devices, in addition to and/or in lieu of those depicted in FIG. 1.

The host computing device 102 may be a desktop or laptop computer, or another type of computing device. The host computing device 102 typically includes an application program 108 and a printer driver 110. As can be appreciated by those of ordinary skill within the art, the host computing device 102 typically includes other components, in addition to those depicted in FIG. 1. The application program 108, which may be a word processing program, a spreadsheet program, a drawing program, or any other type of computer program, generates data 112, such as a word processing file, a spreadsheet file, a drawing file, or another type of file, to be printed by the printing device 104.

The printer driver 110 receives the data 112, and in turn generates a print job 114. The printer driver 110 is software that converts the data 112 generated by the application program 108 into a language or data that the printing device 104 understands, as the print job 114 in the embodiment of FIG. 1. Examples of such languages include PostScript and the printer command language (PCL), which describe the data 112 that is to be printed. Examples of such data include rasterized bit patterns that represent the data 112. However, the printing device 104 cannot typically directly use the data of the print job 114 to form images on sheets of media corresponding to the print job 114, and thus to the data 112. Rather, the printing device 104 usually performs some additional processing on the data of the print job 114 prior to forming images on sheets of media that correspond to the print job 114 and the data 112.

The printing device 104 may be a laser printing device, an inkjet printing device, or another type of printing device. The printing device 104 may be a standalone printer, or an “all-in-one” device that includes printing functionality as well as scanning, copying, faxing, and/or other types of functionality. The printing device 104 includes at least a controller 116 and an electromechanical print engine 118. As can be appreciated by those of ordinary skill within the art, the printing device 104 can include other components, in addition to those depicted in FIG. 1.

The controller 116 includes hardware, software, or a combination of hardware and software, and may be or include the firmware for the printing device 104 in one embodiment. The controller 116 receives the print job 114, and converts the print job to electronic printing data 120. That is, the controller 116 generates the electronic printing data 120 from and based on the print job 114. The electronic printing data 120 includes the actual data that controls the electromechanical print engine 118 to form images 124 on physical media 122, such as paper, that correspond to the data 112 generated by the application program 108 of the host computing device 102.

The electromechanical print engine 118 includes the components by which the images 124 are formed on the physical media 122. The electromechanical print engine 1 18 may be a laser-printing engine where the printing device 104 is a laser-printing device, and may be an inkjet-printing engine where the printing device 104 is an inkjet-printing device. Thus, the electronic printing data 120 controls the printing device 104 to generate the images 124 on the physical media 124 that correspond to the data 112 (and thus to the print job 114).

The electronic printing data 120 is therefore the most specific data that is employing during the printing process within the architecture 100. The data 112 generated by the application program 108 can generally be printed by any suitable printing device, and is not particular to the printing device 104. The print job 114 is more particular and less abstract than the data 112 from which it is generated, but cannot without further processing be directly used to control the electromechanical print engine 118 to form the images 124 on the physical media 122 that correspond to the data 112. By comparison, the electronic printing data 120, which is generated from and on the basis of the print job 114, is the most specific and least abstract, and is the data that actually controls the electromechanical print engine 118 to from the images 124 on the physical media 122.

During the design process of the printing device 104, testing and verification are generally performed to ensure that the entire printing process that has been described is properly performed. In general, the printer driver 110 is tested and verified to ensure that it is properly generating the print job 114 from the data 112. The controller 116 is also tested and verified to ensure that it is properly generating the electronic printing data 120 from the print job 114. Furthermore, the electromechanical print engine 118 is tested and verified to ensure that electromechanical print engine 118 is properly forming the images 124 on the physical media 122 and that correspond to the electronic printing data 120, the print job 114, and the data 112.

However, performing such testing and verification in relation to the actual electromechanical print engine 118 of the printing device 104 can be laborious or wasteful, and even impossible in some situations. In the former case, printing hundreds if not thousands of sample data 112 as images 124 on the physical media 122 can waste significant amounts of colorant, such as toner or ink, as well as paper or other media. Where the printing device 104 is relatively slow, such testing and verification can further be relatively time-consuming. Furthermore, in the latter case, development of the printer driver 110 and the controller 116 may be occurring in parallel with development of the electromechanical print engine 118. As such, a finished prototype of the electromechanical print engine 118 may not even be available for testing and verification, rendering the performance of such testing and verification as to the electromechanical print engine 118 impossible.

Therefore, the architecture 100 includes a simulation/emulation device 106 for testing and verification purposes. The device 106 is most generically an apparatus. The simulation/emulation device 106 may be a computing device, such as a desktop or a laptop computer, or another type of computing device. The simulation/emulation device 106 may be the same or different computing device as the host computing device 102. The simulation/emulation device 106 includes an electronic image file generation component 126 and a testing and verification assistance component 128, each of which may be implemented in hardware, software, or a combination of hardware and software. As can be appreciated by those of ordinary skill within the art, the simulation/emulation device 106 may include other components, in addition to and/or in lieu of those depicted in FIG. 1.

The electronic image file generation component 126 receives or intercepts the electronic printing data 120 from the controller 116. As has been noted, the electronic printing data 120 is actually adapted for the electromechanical print engine 118 to form the images 124 on the physical media 122. Instead, however, the electronic image file generation component 126 generates one or more electronic image files 130 from and corresponding to the electronic printing data 120—and thus which also correspond to the print job 114 and the data 112. The electronic image files 130 electronically mimic the physical output by the electromechanical print engine 118 of the electronic printing data 120 as the images 124 on the physical media 122.

The electronic image files 130 may be single-page or multiple-page tagged image file format (TIFF) files, joint photographic experts group (JPEG or JPG) files, portable document format (PDF) files, portable network graphics (PNG) files, proprietary RAW files, or files in another type of data format. The electronic image files 130 electronically mimic the physical output of the electronic printing data 120 as the images 124 on the physical media 122 in that they are desirably electronic versions and corollaries of such hardcopy images. That is, desirably, there is substantially little or no difference between the electronic image files 130 and the images 124 on the physical media 122, except that the former are digital and electronic, and the latter are physical hardcopies. The manner by which the electronic image file generation component 126 generates the electronic image files 130 is not limited by the embodiments of the invention, and may be achieved as is conventional, and/or in another manner.

The electronic image file generation component 126, and thus the simulation/emulation device 106, therefore generates the electronic image files 130 to virtually simulate and/or virtually emulate the mechanical print engine 118. The electromechanical print engine 118 physically outputs images on the physical media 122 that represent the electronic printing data 120 (which in turn represents the print job 114 and thus the data 112). Likewise, the electronic image file generation component 126 of the simulation/emulation device 106 electronically generates the electronic image files 130 that have images at least substantially identical to the images 124 printed on the physical media 122, but in electronic and digital form.

The testing and verification assistance component 128 receives the electronic image files 130 and adds features to the files 130, to result in the electronic image files 130′ having these added features. The added features are to assist testing and/or verification of one or more of the following. First, the added features assist testing and verification of the generation of the print job 114 from the data 112, to ensure that such generation is properly achieved. Second, the added features assist testing and verification of the generation of the electronic printing data 120 from the print job 114, to ensure that such generation is also properly achieved.

Third, the added features assist testing and verification of the generation of the electronic image files 130 themselves, to ensure that the electronically image files 130 properly mimic the images 124 that are physically output on the physical media 122. Fourth, the added features assist testing and verification of the formation of the images 124 on the physical media 122, based on the electronic printing data 120, where it is known that the electronic image file generation component 126 properly generates the electronic image files 130 corresponding to these images 124. Examples of the types of features that can be added to the electronic image files 130 to result in the electronic image files 130′ are now described in detail.

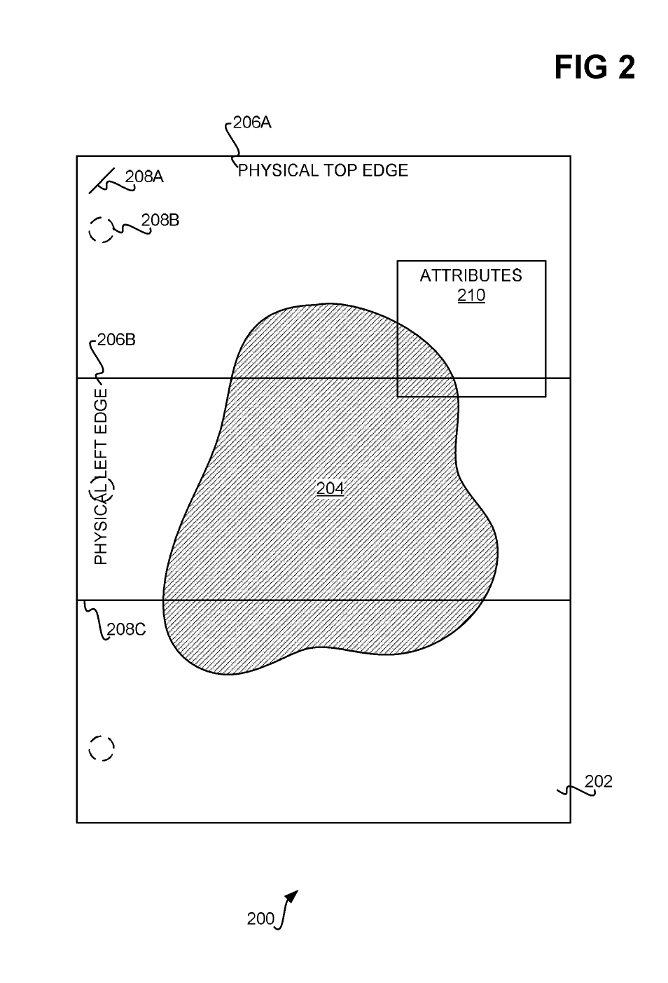

FIG. 2 shows a representative electronic image file 200 having an image 202, as may be generated by the electronic image file generation component 126 of the simulation/emulation device 106, according to an embodiment of the invention. The image 202 corresponds to the image 124 printed on a sheet of a physical medium 122 by the electromechanical print engine 118. For example, the shaded area 204 may be graphics and/or text, both of which are encompassed under the terminology image as used herein, and which may be the data 112 that is actually desired to be printed by the application program 108. Thus, the data 112 is converted into a print job 114, which is converted into electronic printing data 120, which results in a corresponding such image 124 printed on a sheet of a physical medium 122. The desired difference is that the image 202 of the electronic image file 200 is an electronic version of such a hardcopy image 124.

In addition, several features have been added to the image 202 of the electronic image file 200, such as by the testing and verification assistance component 128. Digital watermarks 206A and 206B, collectively referred to as the digital watermarks 206, are features that denote the physical top edge and the physical left edge, respectively, of the sheet of physical media to which the image 202 corresponds. Additionally or alternatively, the digital watermarks 206 may denote the bottom edge and/or the right edge. The digital watermarks 206 are added by overlaying text such as “physical top edge” and “physical left edge” into the image 202 of the electronic image file 200.

The addition of the digital watermarks 206 assists testing and verification, because unlike sheets of actual physical media, the digital image file 200 and the image 202 thereof do not truly have top, left, bottom, and right physical edges. Therefore, a tester or developer can by quickly viewing the image 202 determine whether the orientation of the sheet of physical media to which the image 202 corresponds is correct. Without the addition of the digital watermarks 206, for instance, the tester or developer may have to reference specifications to determine what the orientation should be.

Furthermore, digital watermarks 208A, 208B, and 208C, collectively referred to as the digital watermarks 208, are features that correspond to physical features of the physical media to which the image 202 of the image file 200 corresponds, and/or to non-image physical processing of this physical media. For example, the printing device 104 may have been directed to staple the media sheets on which the print job 114 has been printed together. Because the digital image file 200 cannot actually be stapled, the digital watermark 208A is an image of a staple that corresponds to the stapling of these physical media sheets. Without the addition of the digital watermark 208A, the tester or developer may not be able to easily verify that the electronic printing data 120 is instructing that the physical media sheets be stapled together. The digital watermark 208A thus corresponds to non-image physical processing of such physical media, particularly stapling.

As another example, the printing device 104 may have been directed to print the print job 114 on three hole-punched (or a different number of such holes) sheets of physical media. The digital image file 200 cannot actually include such holes, such that the digital watermark 208B is an image of such holes that corresponds to printing the print job 114 on three hole-punched physical media sheets. Without the addition of the digital watermark 208B, the tester or developer may not be able to easily verify that the electronic printing data 120 is instructing that three hole-punched physical media sheets be employed. The digital watermark 208B thus corresponds to physical features of the physical media to which the image 202 of the image file 200 corresponds, particularly such media having three pre-punched holes.

As a third example, the printing device 104 may have been directed to fold the physical media sheets after the print job 114 has been printed thereon, for fitting into a standard business-size envelope. The digital image file 200 cannot actually be folded. Therefore, the digital watermark 208C is an image of such folds that corresponds to folding the physical media sheets on which the print job 114 is to be printed. Without the addition of the digital watermark 208C, the tester or developer may not be able to easily verify that the electronic printing data 120 is instructing that the physical media sheets be folded after printing. The digital watermark 208C thus corresponds to non-image physical processing of such physical media, particularly folding.

In addition, the overlaid text 210 is a feature that describes one or more attributes regarding the mimicking of the physical output of the electronic printing data 120, by the electromechanical print engine 118, on the physical media 122. For example, the overlaid text 210 may indicate the orientation of the physical media sheet (e.g., portrait or landscape) to which the image 202 of the electronic image file 200 corresponds. The overlaid text 210 may indicate the orientation of the image 202, and thus the image 124 on the physical media sheet 122, itself, such as right side up or upside down. The overlaid text 210 may indicate the size of the physical media sheet to which the image 202 corresponds, such as 8½×11, 11×17, A4, and so on. The overlaid text 210 may indicate the type of the physical media sheet to which the image 202 corresponds, such as letterhead, bond paper, regular paper, and so on. The overlaid text 210 may further indicate whether the physical media sheet to which the image 202 corresponds is being duplexed (i.e., printed on both sides) or not.

Those of ordinary skill within the art can appreciate that the overlaid text 210 can describe other attributes regarding the mimicking of the physical output of the electronic printing data 120 on the physical media 122 by the electromechanical print engine 118. The overlaid text 210 describing these attributes further assist testing and verification. For instance, without description of such attributes within the overlaid text 210 on the image 202 of the electronic image file 200 itself, the developer or tester may have to resort to referencing potentially hard-to-decipher log files to determine whether the electronic printing data 120 properly reflects such attributes.

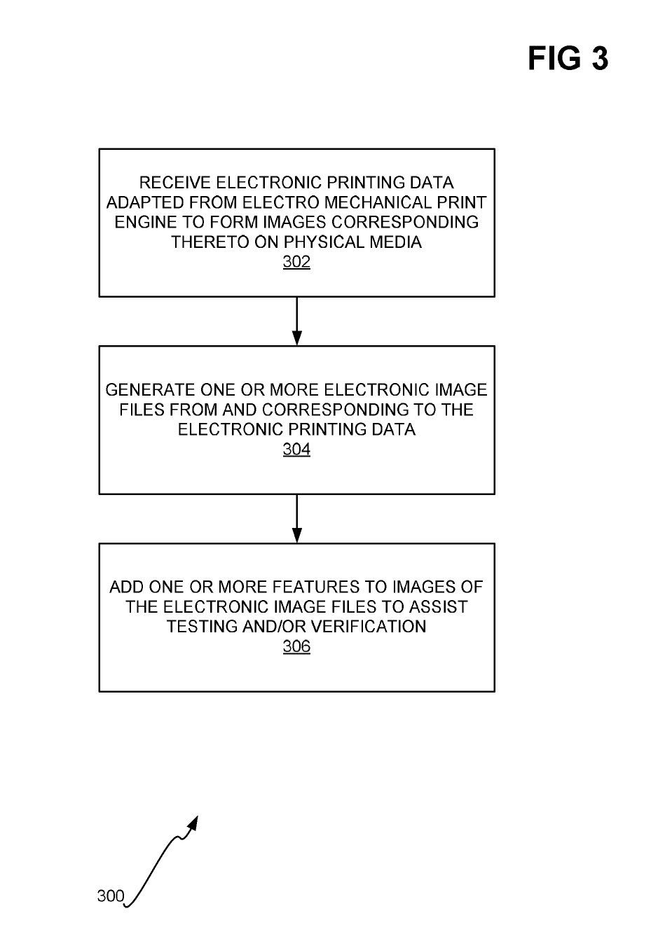

FIG. 3 shows a method 300 that summarizes the detailed description as has been presented, according to an embodiment of the invention. The method 300 may be performed by the simulation/emulation device 106 in one embodiment. The electronic printing data 120 is received (302). As has been noted, the electronic printing data 120 is adapted for the electromechanical print engine 118 to form images 124 on the physical media 122 corresponding to this data 120, and thus to the print job 114 and the data 112. The electronic printing data 120 may be received, such as by being captured, from the controller 116 that adapts the print job 114 into the electronic printing data 120.

Next, one or more electronic image files 130 are generated from and corresponding to the electronic printing data 120 (304). As has been noted, the electronic image files 130 mimic the physical output of the electronic printing data 120 by the electromechanical print engine 118 as the images 124 on the physical media 122. Finally, one or more features are added to the images of the electronic image files 130 (306), to assist testing and/or verification, as has been described. These features can include the digital watermarks 206, the digital watermarks 208, and/or the overlaid text 210 in one embodiment. After the addition of the features to aid in testing and/or verification, the electronic image files 130′ having such added features result.

We claim:

1. A method comprising:
receiving electronic printing data adapted for a electromechanical print engine of a printing device to form images corresponding to the electronic printing data on physical media;
generating one or more electronic image files from and corresponding to the electronic printing data, the electronic image files mimicking physical output of the electronic printing data as images on physical media by the electromechanical print engine; and,
adding one or more features to images of the electronic images files to assist testing and/or verification of one or more of generation of a print job from which the electronic printing data is generated, generation of the electronic printing data from the print job, generation of the electronic image files, and formation of the images corresponding to the electronic printing data on physical media by the electromechanical print engine.

2. The method of claim 1, wherein receiving the electronic printing data comprises receiving the electronic printing data from a printing device controller of the printing device, the printing device controller adapting the print job for the mechanical printing engine of the printing device, as the electronic printing data.

3. The method of claim 1, wherein generating the electronic image files from and corresponding to the electronic printing data comprises one or more of virtually simulating and virtually emulating the electromechanical print engine of the printing device such that the electronic data files mimic the physical output of the electronic printing data as images on physical media by the electromechanical print engine.

4. The method of claim 1, wherein adding the features to the images of the electronic image files comprises adding one or more digital watermarks to each image of each electronic image file, each digital watermark denoting one of a top edge, a bottom edge, a left edge, and a right edge of a sheet of physical media to which the image of the electronic image file corresponds.

5. The method of claim 1, wherein adding the features to the images of the electronic image files comprises adding one or more digital watermarks to each image of each electronic image file, each digital watermark corresponding to a physical feature of the physical media, or to non-image physical processing of the physical media, on which the image of the electronic image file corresponds.

6. The method of claim 5, wherein the digital watermark comprises an image of a staple corresponding to stapling of sheets of the physical media.

7. The method of claim 5, wherein the digital watermark comprises one or more images of punched holes corresponding to punched holes within a sheet of the physical media.

8. The method of claim 5, wherein the digital watermark comprises one or more images of folds corresponding to folds within a sheet of the physical media.

9. The method of claim 1, wherein adding the features to the images of the electronic image files comprises adding overlaid text to each image of each electronic image file, the overlaid text describing one or more attributes regarding mimicking of physical output of the electronic printing data on physical media by the electromechanical print engine.

10. The method of claim 9, wherein the attributes comprise one or more of: orientation of a sheet of physical media to which the image of the electronic image file corresponds; orientation of the image; size of the sheet of physical media to which the image of the electronic image file corresponds; type of the sheet of physical media to which the image of the electronic image file corresponds; and, whether the sheet of physical media to which the image of the electronic image file corresponds is duplexed.

11. An apparatus virtually simulating or emulating a electromechanical print engine of a printing device, the mechanical printing image to form images on physical media, the images corresponding to electronic printing data adapted for the mechanical printing engine by a printing device controller of the printing device, the apparatus comprising:
an electronic image file generation component to generate one or more electronic image files from and corresponding to the electronic printing data to one or more of virtually simulate and virtually emulate the electromechanical print engine, the electronic image files mimicking physical output of the electronic printing data as images on the physical media by the electromechanical print engine; and,
a testing and verification assistance component to add one or more features to images of the electronic images files to assist testing and/or verification of one or more of generation of a print job from which the electronic printing data is generated, generation of the electronic printing data from the print job, generation of the electronic image files, and formation of the images corresponding to the electronic printing data on physical media by the electromechanical print engine.

12. The apparatus of claim 11, wherein the features comprise one or more digital watermarks added to each image of each electronic image file, each digital watermark denoting one of a top edge, a bottom edge, a left edge, and a right edge of a sheet of physical media to which the image of the electronic image file corresponds.

13. The apparatus of claim 11, wherein the features comprise one or more digital watermarks added to each image of each electronic image file, each digital watermark corresponding to a physical feature of the physical media, or to non-image physical processing of the physical media, on which the image of the electronic image file corresponds.

14. The apparatus of claim 13, wherein each digital watermark comprises one or more of:
an image of a staple corresponding to stapling of sheets of the physical media;
one or more images of punched holes corresponding to punched holes within a sheet of the physical media; and,
one or more images of folds corresponding to folds within a sheet of the physical media.

15. The apparatus of claim 11, wherein the features comprise overlaid text added to each image of each electronic image file, the overlaid text describing one or more attributes regarding mimicking of physical output of the electronic printing data on physical media by the electromechanical print engine.

16. The apparatus of claim 15, wherein the attributes comprise one or more of: orientation of a sheet of physical media to which the image of the electronic image file corresponds; orientation of the image; size of the sheet of physical media to which the image of the electronic image file corresponds; type of the sheet of physical media to which the image of the electronic image file corresponds; and, whether the sheet of physical media to which the image of the electronic image file corresponds is duplexed.

17. An apparatus virtually simulating or emulating a electromechanical print engine of a printing device, the mechanical printing image to form images on physical media, the images corresponding to electronic printing data adapted for the mechanical printing engine by a printing device controller of the printing device, the apparatus comprising:
means for generating one or more image files from and corresponding to the electronic printing data to one or more of virtually simulate and virtually emulate the electromechanical print engine, the electronic image files mimicking physical output of the electronic printing data as images on the physical media by the electromechanical print engine; and,
means for adding one or more features to images of the electronic images files to assist testing and/or verification of one or more of generation of a print job from which the electronic printing data is generated, generation of the electronic printing data from the print job, generation of the electronic image files, and formation of the images corresponding to the electronic printing data on physical media by the electromechanical print engine.

18. The apparatus of claim 17, wherein the features comprise one or more digital watermarks added to each image of each electronic image file, each digital watermark denoting one of a top edge, a bottom edge, a left edge, and a right edge of a sheet of physical media to which the image of the electronic image file corresponds.

19. The apparatus of claim 17, wherein the features comprise one or more digital watermarks added to each image of each electronic image file, each digital watermark corresponding to a physical feature of the physical media, or to non-image physical processing of the physical media, on which the image of the electronic image file corresponds, and
wherein each digital watermark comprises one or more of:
an image of a staple corresponding to stapling of sheets of the physical media;
one or more images of punched holes corresponding to punched holes within a sheet of the physical media; and,
one or more images of folds corresponding to folds within a sheet of the physical media.

20. The apparatus of claim 17, wherein the features comprise overlaid text added to each image of each electronic image file, the overlaid text describing one or more attributes regarding mimicking of physical output of the electronic printing data on physical media by the electromechanical print engine, and
wherein the attributes comprise one or more of: orientation of a sheet of physical media to which the image of the electronic image file corresponds; orientation of the image; size of the sheet of physical media to which the image of the electronic image file corresponds; type of the sheet of physical media to which the image of the electronic image file corresponds; and, whether the sheet of physical media to which the image of the electronic image file corresponds is duplexed.
